(19) United States
(12) Patent Application Publication
(10) Pub. No.: US 2023/0170805 A1
(43) Pub. Date: Jun. 1, 2023

(54) DC-DC CONVERTER AND CONTROL METHOD THEREOF

(71) Applicant: BravoTek Electronics Co., Ltd., Zhubei City (TW)

(72) Inventors: Wei-Hsin WEI, Zhubei City (TW); Wei-Chun CHENG, Taipei City (TW)

(21) Appl. No.: 17/581,727

(22) Filed: Jan. 21, 2022

Related U.S. Application Data
(60) Provisional application No. 63/283,323, filed on Nov. 26, 2021.

(51) Int. Cl. H02M 3/158; H02M 1/00; H02M 1/08; H02M 3/157

(52) U.S. Cl. CPC H02M 3/1582; H02M 1/08; H02M 1/0009; H02M 1/009; H02M 3/157

(57) ABSTRACT

A DC-DC converter includes: a power stage having an inductor and a plurality of switches, for generating a plurality of output voltages from an input voltage; a control circuit, for performing time multiplexing constant charge transfer control having valley current control by transferring electrical energy from the input voltage to the plurality of output voltages sequentially one-by-one, further generating a control voltage to control respective output charges of the plurality of output voltages as respective constant predetermined values, and response to all load currents for making input power and output power balance by automatically generating a valley current so that the DC-DC converter switches between DCM and CCM; and a logic control and gate driver for generating a plurality of switch control signals, the plurality of switch control signals for controlling the plurality of switches of the power stage.

This application claims the benefit of U.S. Provisional Application Serial No. 63/283,323, filed Nov. 26, 2021, the subject matter of which is incorporated herein by reference.

### TECHNICAL FIELD

The disclosure relates in general to a DC (direct current)-DC converter and a control method thereof.

### BACKGROUND

Consumers expect hearables, wearables, and other ultra-small electronic devices to be long on battery life despite their tiny form factor. The device size does limit the battery capacity.

New consumer wearable, hearable and connected devices are continually getting smaller and less invasive. Engineers face increasing challenges trying to pack all the necessary product features into a tiny form factor of an earbud or a wearable gadget such as a watch, bracelet, or skin patch. These space-constrained products benefit from tiny low-power power management circuits using space-saving SIMO (single-inductor, multiple-output) technology.

A single-inductor multiple-output (SIMO) architecture provides a better solution for tiny devices requiring good thermal performance, by integrating functionality in smaller devices that would otherwise require multiple discrete components. A SIMO DC-DC converter can support multiple voltage outputs while using only one inductor. For form factor constraint applications, the SIMO DC-DC converter is very attractive to possibly perform the best trade-off between size, weight, overall cost and power conversion efficiency for multi-channel power management integrated circuit (PMIC) applications. The control methods for SIMO DC-DC converters can be classified into two categories: time-multiplexing control (TMC) and ordered-power-distributive control (OPDC).

There are commercial SIMO DC-DC converters adopting TMC to perform good power efficiency at light load; however, its maximum load current is limited since they can operate at only DCM control. Although a SIMO DC-DC converter controlled with OPDC (Ordered Power Distributive Control) scheme can operate at both DCM and continuous conduction mode (CCM) to provide a larger output current capability. The DCM control with OPDC scheme cannot have good light load efficiency.

Still further, we can combine the TMC control and OPDC into a SIMO DC-DC converter to perform TMC operation at light load and OPDC operation at heavier load can optimize light load efficiency with good heavy load capability. However, the transition between TMC and OPDC operations will cause larger voltage ripple due to the different operation mode transition.

Since a SIMO DC-DC converter can support multiple outputs while using only one inductor, it is an excellent candidate to minimize the component count and thus reduce the production cost. Apparently, the area of print circuit board can be reduced greatly, thereby miniaturizing devices. Minimizing the cross regulation and output voltage ripple are also required in SIMO DC-DC converter design while improving the power delivery quality and the load driving capability are also important. The SIMO DC-DC converter as the key device should deliver small output voltage ripple and sufficient current capability, remove cross-regulation and perform good power efficiency for whole load current range and transient conditions. To achieve these goals, a new SIMO architecture with novel control scheme is still demanding.

### SUMMARY

According to one embodiment of the application, provided is a DC-DC converter including: a power stage having an inductor and a plurality of switches coupled to the inductor, the power stage generating a plurality of output voltages from an input voltage; a control circuit coupled to the power stage, the control circuit performing time multiplexing constant charge transfer control having valley current control by transferring electrical energy from the input voltage to the plurality of output voltages sequentially one-by-one, the control circuit further generating a control voltage to control respective output charges of the plurality of output voltages as respective constant predetermined values, and the control circuit response to all load currents for making input power and output power balance by automatically generating a valley current so that the DC-DC converter switches between a discontinuous conduction mode (DCM) and a continuous conduction mode (CCM) depending on different valley current levels; and a logic control and gate driver, coupled to the control circuit and the power stage, the logic control and gate driver generating a plurality of switch control signals based on a plurality of control signals from the control circuit, the plurality of switch control signals for controlling the plurality of switches of the power stage.

According to another embodiment, provided is a control method for a DC-DC converter, the control method including: generating a plurality of output voltages from an input voltage by a power stage having an inductor and a plurality of switches coupled to the inductor; performing time multiplexing constant charge transfer control having valley current control by transferring electrical energy from the input voltage to the plurality of output voltages sequentially one-by-one; generating a control voltage to control respective output charges of the plurality of output voltages as respective constant predetermined values; response to all load currents, making input power and output power balance by automatically generating a valley current so that the DC-DC converter switches between a discontinuous conduction mode (DCM) and a continuous conduction mode (CCM) depending on different valley current levels; and generating a plurality of switch control signals based on a plurality of control signals, the plurality of switch control signals for controlling the plurality of switches of the power stage.

### BRIEF DESCRIPTION OF THE DRAWINGS

FIG. 1 shows a circuit diagram of a SIMO (Single Inductor Multiple Output) DC-DC converter according to one embodiment of the application.

FIG. 2 shows a circuit diagram of a SIMBO (Single Inductor Multiple Bipolar Output) DC-DC converter according to one embodiment of the application.

FIG. 3 shows inductor current waveforms and switching sequence for various conversion modes of the SIMBO DC-DC converter according to one embodiment of the application.

FIG. 4 shows TMCCT according to one embodiment of the application.

FIG. 5A and FIG. 5B show two possible of the peak current detector in one embodiment of the application.

FIG. 6A to FIG. 6D show various conversion modes of TMCCT according to one embodiment of the application.

FIG. 7 shows operations of the mode decision circuit according to one embodiment of the application.

FIG. 8 shows the waveforms of the FIFO and priority logic 123 according to one embodiment of the application.

FIG. 9A shows a circuit diagram of the valley voltage generator and the valley current detector according to one embodiment of the application.

FIG. 9B shows the waveforms of the valley voltage generator and the valley current detector according to one embodiment of the application.

FIG. 10 shows an example of switch logic waveforms according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENT

Technical terms of the disclosure are based on general definition in the technical field of the disclosure. If the disclosure describes or explains one or some terms, definitions of the terms are based on the description or explanation of the disclosure. Each of the disclosed embodiments has one or more technical features. In possible implementation, one skilled person in the field could selectively implement part or all technical features of any embodiment of the disclosure or selectively combine part or all technical features of the embodiments of the disclosure.

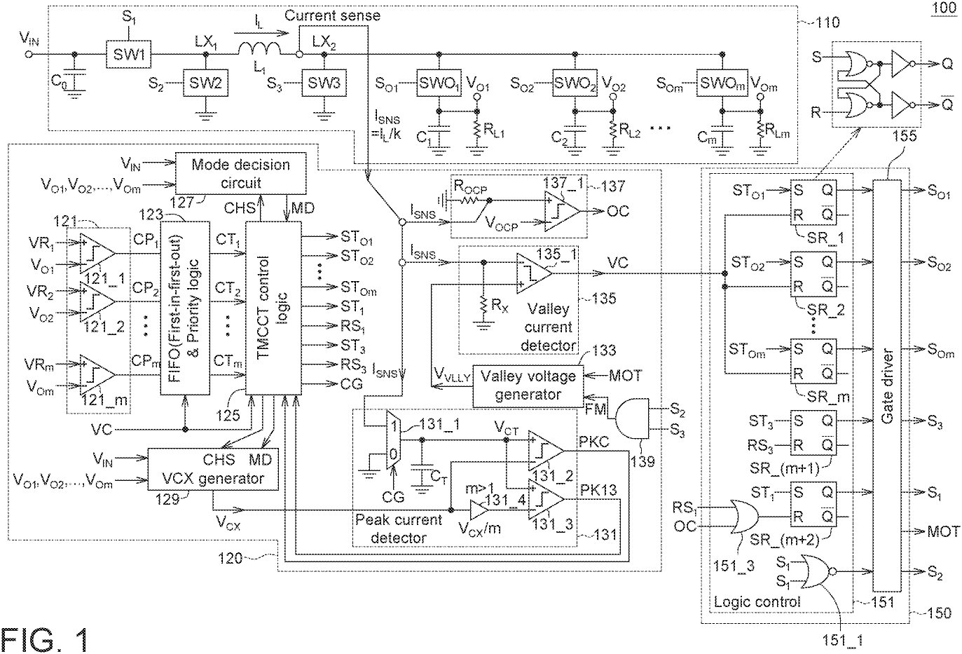

FIG. 1 shows a circuit diagram of a SIMO (Single Inductor Multiple Output) DC-DC converter according to one embodiment of the application. As shown in FIG. 1, the SIMO DC-DC converter 100 according to one embodiment of the application includes a power stage 110, a control circuit 120 and a logic control and gate driver 150. The power stage 110 of the SIMO DC-DC converter 100 generates a plurality of output voltages V_{O1}, V_{O2}, ..., V_{Om} (m being a positive integer) from an input voltage V_{IN}. In the following, the SIMO DC-DC converter 100 has a plurality of channels; and a channel is defined as a signal path for generating an output voltage among the plurality of output voltages V_{O1}, V_{O2}, ..., V_{Om}. The plurality of output voltages V_{O1}, V_{O2}, ..., Vom may be also referred as channel output voltages. Also, the plurality of output voltages V_{O1}, V_{O2}, ..., Vom are positive output voltages.

The power stage 110 includes an inductor L₁, a plurality of switches SW1, SW2, SW3, SWO₁, SWO₂, ..., SWOₘ, a plurality of capacitors C₀, C₁, C₂, ... Cₘ, and a plurality of loads (for example but not limited by resistors R_{L1}, R_{L2}..., R_{Lm}). The switches SW1, SW2, SW3 are also referred as input switches while the switches SWO₁, SWO₂, ..., SWOₘ are also referred as output switches.

The inductor L₁ is coupled between a first node LX1 and a second node LX2. An inductor current I_{L} flows through the inductor L₁. The inductor L₁ is coupled to the switches SW1, SW2, SW3, SWO₁, SWO₂, ..., SWOₘ.

The switch SW1 is coupled between the input voltage V_{IN} and the first node LX1. The switch SW2 is coupled between a ground terminal GND and the first node LX1. The switch SW3 is coupled between the input voltage V_{IN} and the second node LX2. The switch SWO₁ is coupled between the second node LX2 and the first output voltage V_{O1}. The switch SWO₂ is coupled between the second node LX2 and the second output voltage V_{O2}. The switch SWOₘ is coupled between the second node LX2 and the m-th output voltage Vom.

The capacitor C₀ is coupled between the input voltage V_{IN} and the ground terminal GND. The plurality of capacitors C₁, C₂, ... Cₘ, and the plurality of loads R_{L1}, R_{L2}..., R_{Lm} are coupled in parallel between the output voltages V_{O1}, V_{O2}, ... V_{Om} and the ground terminal GND, respectively. Still further, the power stage 110 has a current sense circuit which senses a current I_{SNS}=I_{L}/k (k being a positive number) to the control circuit 120. The current I_{L}/k is 1/k of the inductor current I_{L}.

The switches SW1, SW2, SW3, SWO₁, SWO₂, ..., SWOₘ are controlled by a plurality of switch control signals S₁, S₂, S₃, S_{O1}, S_{O2}, ..., S_{Om}, respectively. The switch control signals S₁, S₂, S₃, S_{O1}, S_{O2}, ..., S_{Om} are generated by the control circuit 120 and the logic control and gate driver 150.

The control circuit 120 is coupled to the power stage 110. The control circuit 120 includes a voltage comparator (CMP) circuit 121 having a plurality of voltage comparators (CMPs) 121_1~121_m, a FIFO (first-in-first-out) and priority logic 123, a Time Multiplexing Constant Charge Transferred (TMCCT) control logic 125, a mode decision circuit 127, a control voltage generator 129, a peak current detector 131, a valley voltage generator 133, a valley current detector 135, an overcurrent protection circuit 137, and a logic gate 139.

The sense current I_{SNS}=I_{L}/k from the power stage 110 is fed into the control circuit 120 (k being a constant number). Also, the sense current I_{SNS} from the power stage 110 is fed into the peak current detector 131 for peak current control. Also, the sense current I_{SNS} from the power stage 110 is fed into the valley voltage generator 133 for generating the valley voltage. Also, the sense current I_{SNS} from the power stage 110 is fed into the overcurrent protection circuit 137 for overcurrent protection.

The plurality of voltage comparators 121_1~121_m generate a plurality of voltage comparator output signals CP₁~CPₘ based on the output voltages V_{O1}, V_{O2}, ... Vom and a plurality of reference voltages VR₁, VR₂, ..., VRₘ, respectively. For example but not limited by, the plurality of voltage comparators 121_1~121_m generate the plurality of voltage comparator output signals CP₁~CPₘ as high when the output voltages V_{O1}, V_{O2}, ... Vom are lower than the plurality of reference voltages VR₁, VR₂, ..., VRₘ, respectively. The voltage comparator output signals CP₁~CPₘ are input into the FIFO and priority logic 123. When the output voltages V_{O1}, V_{O2}, ... Vom are lower than the reference voltages VR₁, VR₂, ..., VRₘ, it means the corresponding channel need to receive more power from the input voltage V_{IN}. When the voltage comparator output signals CP₁~CPₘ are logic high, the control circuit 120 will control to supply power to the corresponding channel whose output voltage is lower than the reference voltage.

The FIFO and priority logic 123 is coupled to the plurality of voltage comparators 121_1~121_m for performing FIFO and priority determination on outputs CP₁~CPₘ from the plurality of voltage comparators 121_1~121_m to generate a plurality of signals CT₁~CTₘ based on the valley current VC.

The TMCCT control logic 125 decides the switching sequence for the selected channel in response to outputs from the valley current detector 135, the peak current detector 131, and the mode decision circuit 127 based on the a plurality of signals CT₁~CTₘ, the valley current VC, the mode signal MD (from the mode decision circuit 127) and the peak current signals PKC and PK13.

The mode decision circuit 127 decides the conversion mode for the selected channel based on the channel select signal CHS and the input voltage V_{IN} and the output voltages V_{O1}, V_{O2}, ... V_{Om}.

The control voltage generator 129 generates a control voltage V_{CX} to the peak current detector for controlling the output charge as a constant predetermined value based on the channel select signal CHS, the mode signal MD and the input voltage V_{IN} and the output voltages V_{O1}, V_{O2}, ... V_{Om}.

The peak current detector 131 detects the sense current I_{SNS} to determine whether the sense current I_{SNS} exceeds a threshold which is corresponding to the control voltage V_{CX}. If yes, the output signal PKC from the peak current detector 131 will terminate the inductor current charging phases for all conversion modes.

The peak current detector 131 includes a multiplexer 131_1, two voltage comparators 131_2 and 131_3, a capacitor C_{T} and a voltage divider 131_4.

The multiplexer 131_1 selects one among the two input (the sense current I_{SNS} and GND) as the voltage V_{CT} (which is the cross voltage on the capacitor C_{T}) under control of the enable signal CG from the TMCCT control logic 125. For example but not limited by, when the enable signal CG is logic 1, the multiplexer 131_1 selects the sense current I_{SNS} and vice versa.

The voltage comparator 131_2 compares the voltage V_{CT} with the control voltage V_{CX} to generate the peak current PKC. For example but not limited by, when the voltage V_{CT} is higher than the control voltage V_{CX}, the voltage comparator 131_2 generates the high peak current PKC and vice versa.

The voltage comparator 131_3 compares the voltage V_{CT} with the control voltage Vcx/m (m>1) to generate the peak current PK13. For example but not limited by, when the voltage V_{CT} is higher than the control voltage Vcx/m, the voltage comparator 131_3 generates the high peak current PK13 and vice versa.

The capacitor C_{T} is coupled to the output of the multiplexer 131_1.

The voltage divider 131_4 receives the control voltage V_{CX} to output the control voltage V_{CX}/m (m>1).

The valley voltage generator 133 generates the valley voltage V_{VLLY} to the valley current detector 135 based on the signal MOT and the free-wheel cycle FW. Details of the valley voltage generator 133 are described as follows.

The valley current detector 135 generates the valley current signal VC based on the sense current I_{SNS} and the valley voltage V_{VLLY} from the valley voltage generator 133.

The valley current detector 135 includes a voltage comparator 135_1 and a resistor Rx. The voltage comparator 135_1 compares the valley voltage V_{VLLY} with the voltage Rx*I_{SNS}. The resistor Rx is coupled to the voltage comparator 135_1.

For example but not limited by, when the valley voltage V_{VLLY} is higher than the voltage Rx*I_{SNS}, the voltage comparator 135_1 generates the valley current signal VC as logic high and vice versa.

The overcurrent protection circuit 137 includes a voltage comparator 137_1 for comparing a sense voltage (equal to I_{SNS}*R_{OCP}) with a reference current V_{OCP}. When the sense voltage exceeds the reference current V_{OCP}, the overcurrent protection circuit 137 outputs a high overcurrent indication signal OC to the logic control and gate driver 150. In response to the overcurrent indication signal OC, the logic control and gate driver 150 resets the switch control signal S₁ to logic low to turn off the switch SW1 and thus stops energy transfer from the input voltage V_{IN} to the inductor L₁. By so, the overcurrent protection is achieved.

The logic gate 139 generates the free-wheel (FW) duty cycle based on the switch control signals S₂ and S₃. For example but not limited by, the logic gate 139 is an AND logic gate; and thus the logic gate 139 generates the high free-wheel (FW) duty cycle when both the switch control signals S₂ and S₃ are logic high.

The logic control and gate driver 150 is coupled to the power stage 110 and the control circuit 120. The logic control and gate driver 150 generates the plurality of switch control signals S₁, S₂, S₃, S_{O1}, S_{O2}, ..., S_{Om}, and the signal MOT.

The logic control and gate driver 150 includes a logic control 151 and a gate driver 155.

The logic control 151 includes a first logic 151_1, a second logic 151_3 and a plurality of SR flip-flops SR_1~SR_(m+2).

The first logic 151_1 generates an output based on the switch control signal S₁. The output of the first logic 151_1 is fed into the gate driver 155 for generating the switch control signal S₂.

The second logic 151_3 generates an output based on the signal RS₁ and the over current OC. The output of the second logic 151_2 is input into the SR flip-flop SR_(m+2).

The SR flip-flop SR_(m+1) generates an output based on the signals RS₃ and ST₃.

The SR flip-flops SR_1~SR_m generate outputs based on the signals ST_{O1}~ST_{Om} and the valley current VC.

The gate driver 155 generates the signals S₁, S₂, S₃, S_{O1}, S_{O2}, ..., S_{Om}, and MOT based on the outputs from the first logic 151_1, the second logic 151_3 and the plurality of SR flip-flops SR_1~SR_(m+2).

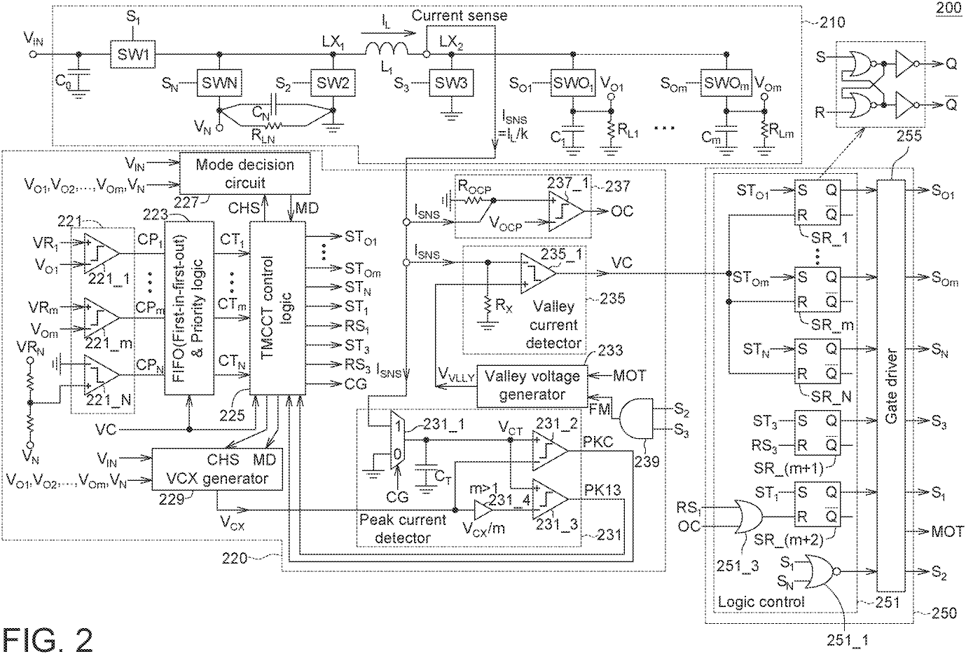

FIG. 2 shows a circuit diagram of a SIMBO (Single Inductor Multiple Bipolar Output) DC-DC converter 200 according to one embodiment of the application. As shown in FIG. 2, the SIMBO DC-DC converter 200 according to one embodiment of the application includes a power stage 210, a control circuit 220 and a logic control and gate driver 250. The power stage 210 of the SIMBO DC-DC converter 200 generates a plurality of positive output voltages V_{O1}, V_{O2}, ..., Vom and a negative output voltage V_{N} from the input voltage V_{IN}. In the following, the SIMBO DC-DC converter 200 has a plurality of channels; and a channel is defined as a signal path for generating an output voltage among the plurality of output voltages V_{O1}, V_{O2}, ..., V_{Om}, V_{N}. The plurality of output voltages V_{O1}, V_{O2}, ..., V_{Om}, V_{N} may be also referred as channel output voltages.

The power stage 210 includes an inductor L₁, a plurality of switches SW1, SW2, SW3, SWO₁, SWO₂, ..., SWOₘ, SWN, a plurality of capacitors C₀, C₁, C₂, ... Cₘ, C_{N}, and a plurality of loads (for example but not limited by resistors R_{L1}, R_{L2}..., R_{Lm}, R_{LN}).

The power stage 210 of the SIMBO DC-DC converter 200 is similar to the power stage 110 of the SIMO DC-DC converter 100 and thus the details are omitted here.

The control circuit 220 is coupled to the power stage 210. The control circuit 220 includes a voltage comparator (CMP) circuit 221 having a plurality of voltage comparator 221_1~221_m and 221_N, a FIFO and priority logic 223, a Time Multiplexing Constant Charge Transferred (TMCCT) control logic 225, a mode decision circuit 227, a control voltage generator 229, a peak current detector 231 (including a multiplexer 231_1, two voltage comparators 231_2 and 231_3, a capacitor C_{T} and a voltage divider 231_4), a valley voltage generator 233, a valley current detector 235 (including a voltage comparator 235_1 and a resistor Rx), an overcurrent protection circuit 237 (including a voltage comparator 237_1 and a resistor R_{OCP}), and a logic gate 239.

The control circuit 220 of the SIMBO DC-DC converter 200 is similar to the control circuit 120 of the SIMO DC-DC converter 100 and thus the details are omitted here.

The logic control and gate driver 250 is coupled to the power stage 210 and the control circuit 220. The logic control and gate driver 250 generates the plurality of switch control signals S₁, S₂, S₃, S_{O1}, S_{O2}, ..., S_{Om}, S_{N}, and the signal MOT.

The logic control and gate driver 250 includes a logic control 251 (including a first logic 251_1, a second logic 251_3 and a plurality of SR flip-flops SR_1~SR_(m+2) and SR_N) and a gate driver 255.

The logic control and gate driver 250 of the SIMBO DC-DC converter 200 is similar to the logic control and gate driver 150 of the SIMO DC-DC converter 100 and thus the details are omitted here.

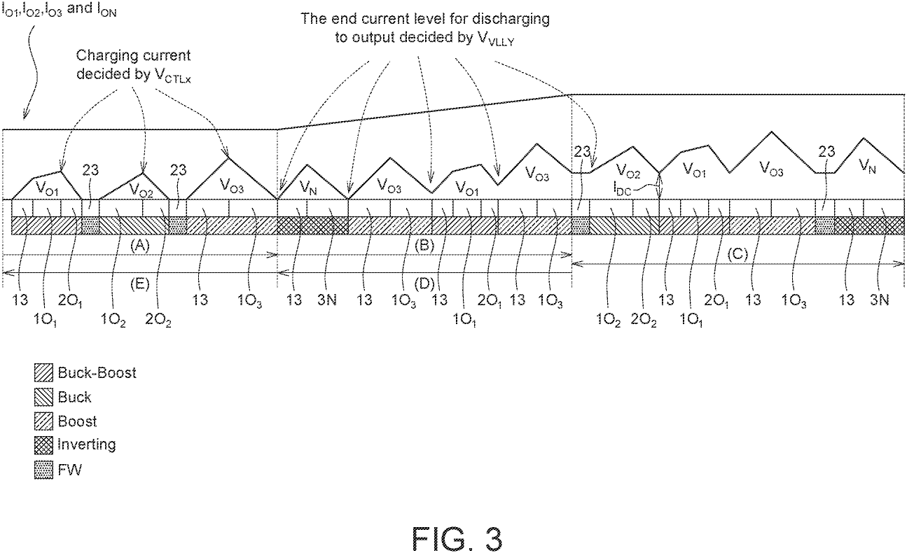

FIG. 3 shows inductor current waveforms and switching sequence for various conversion modes of the SIMBO DC-DC converter 200 according to one embodiment of the application. However, FIG. 3 is also applicable to the SIMO DC-DC converter 100 according to one embodiment of the application.

In the cycle (A), the SIMBO DC-DC converter 200 sequentially operates in the buck-boost mode, the Free-Wheel (FW) mode, the buck mode, the FW mode and the boost mode. During the buck-boost mode, the symbol “13” refers to that the switches SW1 and the SW3 are turned on. During the buck-boost mode, the switches SW1 and SW3 are turned on and thus power is supplied from the input voltage V_{IN} to the inductor L₁ to increase the inductor current I_{L}. Then, the switches SW1 and SWO₁ are turned on to transfer the power stored in the inductor L₁ into the output voltage V_{O1}. Then, the switches SW2 and SWO₁ are turned on to release the redundant power from the output voltage V_{O1} to GND to decrease the inductor current I_{L} till zero.

During the cycle (A), all output current I_{O1}, I_{O2}, I_{O3} and I_{ON} are constant; and the total FW period in each switching cycle is longer than a predetermined value t_{A}. Thus, the valley voltage V_{VLLY} is reduced till zero and also the DC current I_{DC} is reduced till zero. During the cycle (A), the charging current is decided by the peak current control voltage V_{CX} generated by the control voltage generator 129.

In the cycle (B), the SIMBO DC-DC converter 200 sequentially operates in the inverting mode, the boost mode, the buck-boost mode and the boost mode.

During the cycle (B), one or more of the output current I_{O1}, I_{O2}, I_{O3} and I_{ON} goes to a larger level; and the total FW period in a predetermined number of switching cycles is shorter than another predetermined value t_{B} (t_{B}<t_{A}). Thus, the valley voltage V_{VLLY} is increased and also the DC current I_{DC} is increased. During the cycle (B), the end current level for discharging to the output channel is decided by the valley voltage V_{VLLY}.

In the cycle (C), the SIMBO DC-DC converter 200 sequentially operates in the FW mode, the buck mode, the buck-boost mode, the boost mode, the FW mode and the inverting mode.

During the cycle (C), the output current I_{O1}, I_{O2}, 1_{O3} and I_{ON} keep constant; and the total FW period in a predetermined number of switching cycle is shorter than t_{A} and longer than t_{B} (tB<tA). Thus, the valley voltage V_{VLLY} keeps and also the DC current I_{DC} keeps.

In the cycle (D), the SIMBO DC-DC converter 200 sequentially operates in the boost mode, the buck-boost mode, the boost mode and the inverting mode.

During the cycle (D), one or more of the output current I_{O1}, I_{O2}, 1_{O3} and I_{ON} goes to a lower level; and the total FW period in a predetermined number of switching cycle is longer than t_{A}. Thus, the valley voltage V_{VLLY} is reduced to zero and also the DC current I_{DC} is reduced to zero. During the cycle (D), the end current level for discharging to the output channel is decided by the valley voltage V_{VLLY}.

In the cycle (E), the SIMBO DC-DC converter 200 sequentially operates in the boost mode, the FW mode, the buck mode, the FW mode and the buck-boost mode.

During the cycle (E), all output current I_{O1}, I_{O2}, 1_{O3} and I_{ON} are constant; and the total FW period in a predetermined number of switching cycle is longer than t_{A}. The DC current IDC is reduced gradually till zero. Longer FW period means lower output current loading.

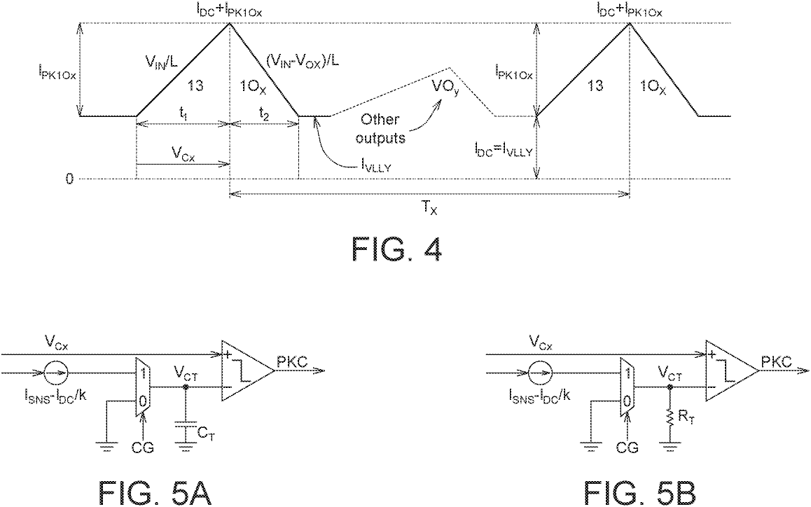

FIG. 4 shows TMCCT according to one embodiment of the application. In FIG. 4, the boost conversion mode is taken an example but the application is not limited by.

The peak current I_{PK1Ox} is the increased inductor current level at the inductor charging phase t₁ and the decreased inductor current level at the inductor discharging phase t₂. That is, during the inductor charging phase t₁, the inductor current I_{L} is increased from the DC current I_{DC} (equal to the valley current I_{VLLY}) to “I_{DC}+I_{PK1Ox}”, and in the inductor discharging phase t₂, the inductor current I_{L} is decreased from “I_{DC}+I_{PK1Ox}”to the valley current I_{VLLY}.

The inductor charging phase t₁ and the inductor discharging phase t₂ are expressed as the formula (1).

$$\begin{matrix}{\text{t}}_{1} {\text{= I}}_{\text{PK10x}} {\text{*L/V}}_{\text{IN}} \\ \\ {\text{t}}_{2} {\text{= I}}_{\text{PK10x}} \text{*L/} \left({\text{V}}_{\text{Ox}} {\text{-V}}_{\text{IN}}\right)\end{matrix}$$

The total output charge Qox is expressed as the formula (2).

$$\begin{matrix}\text{Total output charge:} {Q}_{O x} \\ = {\int }_{0}^{{t}_{2}} \left({I}_{D C} + {I}_{P K 1 O x} - \frac{{V}_{O x} - {V}_{I N}}{L} ⋅ t\right) \text{d} t \\ = \frac{L ⋅ {I}_{P K 1 O x}}{\left({V}_{O x} - {V}_{I N}\right)} ⋅ \left(\frac{{I}_{P K 1 O x}}{2} + {I}_{D C}\right)\end{matrix}$$

The output current lox is expressed as the formula (3).

$$\text{Output current:} {I}_{O x} = \frac{{Q}_{O x}}{{T}_{x}} = \frac{1}{{T}_{x}} ⋅ \frac{L ⋅ {I}_{P K 1 O x}}{\left({V}_{O x} - {V}_{I N}\right)} ⋅ \left(\frac{{I}_{P K 1 O x}}{2} + {I}_{D C}\right)$$

Output voltage ripple V_{PPOx} of the output voltage V_{Ox} is expressed approximately as the formula (4).

$$\begin{matrix}\text{Output voltage ripple of} {V}_{O x} : {V}_{P P O x} ≅ \\ \frac{1}{{C}_{x}} ⋅ \frac{L ⋅ {I}_{P K 1 O x}}{\left({V}_{O x} - {V}_{I N}\right)} ⋅ \left(\frac{{I}_{P K 1 O x}}{2} + {I}_{D C}\right)\end{matrix}$$

The precise output voltage ripple should also consider the charge reduced on the output cap sunk by the load current during the switching period, which is ignored in this formula.

While the DC current is zero (I_{DC}=0), the total output charge Q_{OX0}, the output current I_{OX0} and the output voltage ripple V_{PPOx} of the output voltage V_{Ox} are expressed as the formula (5).

$$\begin{matrix}\text{Total output charge:} {Q}_{O x 0} \left(@ {I}_{D C} = 0\right) \frac{L ⋅ {I}_{P K 1 O x}^{2}}{2 \left({V}_{O x} - {V}_{I N}\right)} \\ \text{Output current:} {I}_{O x 0} \left(@ {I}_{D C} = 0\right) = \frac{{Q}_{O x}}{{T}_{x}} = \frac{L ⋅ {I}_{P K 1 O x}^{2}}{2 {T}_{x} \left({V}_{O x} - {V}_{I N}\right)}\end{matrix}$$

$$\begin{matrix}\text{Output voltage ripple of} {V}_{O x 0} : {V}_{P P O x} \left(@ {I}_{D C} = 0\right) \\ ≅ \frac{L ⋅ {I}_{P K 1 O x}^{2}}{2 {C}_{x} \left({V}_{O x} - {V}_{I N}\right)}\end{matrix}$$

In one embodiment, the switching cycle (t₁ + t₂) depends on the inductance of the inductor L₁, the input voltage V_{IN}, the output voltage Vox and the peak current I_{PK1Ox}.

In one embodiment, a control scheme is designed to transfer the output charge Q_{Ox0} as a constant at the zero DC current (I_{DC}=0) for the corresponding output channel. Thus, in one embodiment, the output current capability can be increased by rising the valley current (I_{VLLY}=I_{DC}) value. However, in possible example, the output voltage ripple V_{PPOx} of the output voltage Vox becomes larger while the DC current I_{DC} goes larger.

Still, in one embodiment, While the DC current is higher than zero (I_{DC}>0), the total output charge Q_{OX0}, the output current I_{OX0} and the output voltage ripple V_{PPOx} of the output voltage V_{Ox} are expressed as the formula (6).

$$\begin{matrix}\text{Total output charge:} {Q}_{O x} \\ = \frac{L ⋅ {I}_{P K 1 O x}}{\left({V}_{O x} - {V}_{I N}\right)} ⋅ \left(\frac{{I}_{P K 1 O x}}{2} + {I}_{D C}\right) \\ = {Q}_{O x 0} + \frac{L ⋅ {I}_{P K 1 O x}}{\left({V}_{O x} - {V}_{I N}\right)} ⋅ {I}_{D C}\end{matrix}$$

$$\begin{matrix}\text{Output current:} {I}_{O x} = \frac{{Q}_{O x}}{{T}_{x}} = \frac{1}{{T}_{x}} ⋅ \frac{L ⋅ {I}_{P K 1 O x}}{\left({V}_{O x} - {V}_{I N}\right)} ⋅ \left(\frac{{I}_{P K 1 O x}}{2} + {I}_{D C}\right) \\ = \frac{{Q}_{O x 0}}{{T}_{x}} + \frac{1}{{T}_{x}} ⋅ \frac{L ⋅ {I}_{P K 1 O x}}{\left({V}_{O x} - {V}_{I N}\right)} ⋅ {I}_{D C} \\ {\text{Output voltage ripple of V}}_{O x} : {V}_{P P O x} \\ ≅ \frac{1}{{C}_{O x}} ⋅ \frac{L ⋅ {I}_{P K 1 O x}}{\left({V}_{O x} - {V}_{I N}\right)} ⋅ \left(\frac{{I}_{P K 1 O x}}{2} + {I}_{D C}\right) \\ = \frac{{Q}_{O x 0}}{{C}_{O x}} + \frac{L ⋅ {I}_{P K 1 O x}}{{C}_{O x} ⋅ \left({V}_{O x} - {V}_{I N}\right)} ⋅ {I}_{D C}\end{matrix}$$

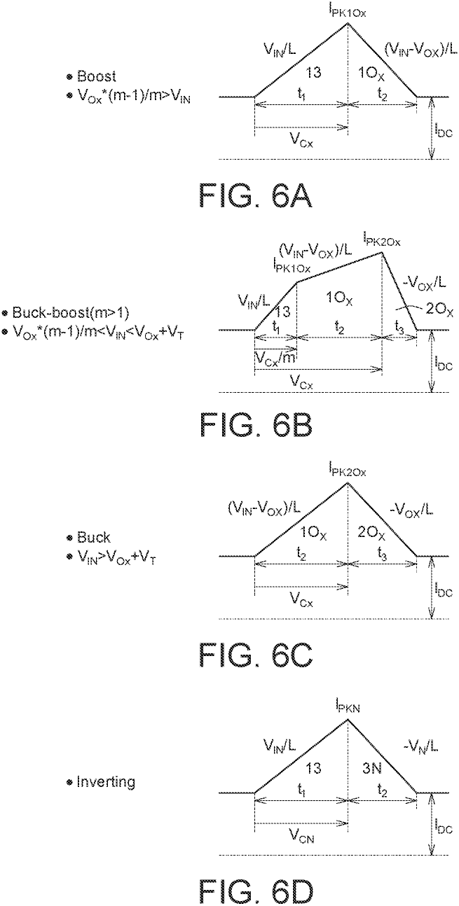

Now, TMCCT switch control scheme in one embodiment of the application is described. FIG. 5A and FIG. 5B show two possible of the peak current detector 131 in one embodiment of the application.

FIG. 5A shows peak current controlled integrating (I_{SNS}-I_{DC})/k with the capacitor C_{T}. FIG. 5B shows peak current controlled by peak current detection.

In one embodiment, the inductor charging phase (i.e. t₁ in FIG. 4) stops at the inductor peak current achieving I_{DC}+I_{PK1OX}; and the inductor discharging phase (i.e. t₂ in FIG. 4) stops as the inductor current achieving the valley current I_{VLLY} (I_{VLLY}=I_{DC}). The valley current is decided by the valley current detector 135 and the valley voltage generator 133.

In one embodiment, the total integrated charge Q_{CT} at the capacitor C_{T} at the inductor charging phase is expressed as the formula (7).

$$\begin{matrix}{Q}_{C T} = {\int }_{0}^{{t}_{1}} \left({I}_{S N S} \left(t\right) - \frac{{I}_{D C}}{k}\right) ⋅ \text{d} t = {\int }_{0}^{{t}_{1}} \frac{{I}_{L} \left(t\right) - {I}_{D C}}{k} ⋅ \text{d} t = \\ {\int }_{0}^{{t}_{1}} \frac{{V}_{I N}}{k L} ⋅ t ⋅ \text{d} t = \frac{L ⋅ {I}_{P K 1 O x}^{2}}{2 k {V}_{I N}} = {C}_{T} \times {V}_{C x}\end{matrix}$$

In one embodiment, in FIG. 5A, the peak current control voltage V_{CX} is expressed as the formula (8).

$$\begin{matrix}\text{Peak current control voltage:} {V}_{C x} = \frac{L ⋅ {I}_{P K 1 \text{O} x}^{2}}{2 k {V}_{I N} {C}_{T}} = \\ \frac{{Q}_{O x 0}}{k {C}_{T}} \times \frac{{V}_{O x} - {V}_{I N}}{{\text{V}}_{\text{IN}}}\end{matrix}$$

In one embodiment, in FIG. 5B, the peak current control voltage V_{CX} is expressed as the formula (9).

$$\begin{matrix}{\text{V}}_{\text{C} x} = \left(\frac{{I}_{P K 1 O x} + {I}_{D C}}{k} - \frac{{I}_{D C}}{k}\right) \times {R}_{T} = \frac{{I}_{P K 1 O x}}{k} \times {R}_{T} = \\ \frac{{R}_{T}}{k} \sqrt{\frac{2 \left({V}_{O x} - {V}_{I N}\right) {Q}_{O x 0}}{L}}\end{matrix}$$

Q_{Ox0} is a parameter to determine the output charge of the selected output channel for each conversion so that the control scheme is referred as the time-multiplexing constant charge transferred control scheme.

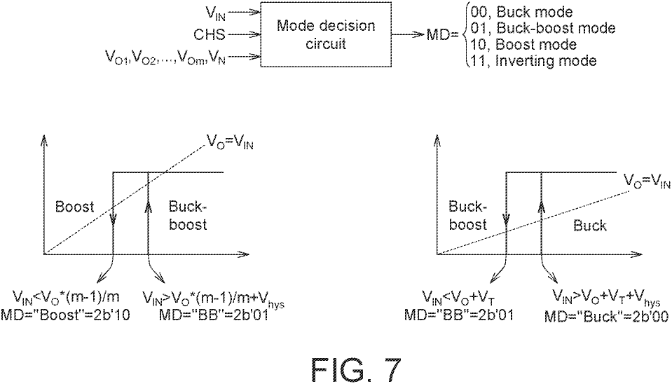

FIG. 6A to FIG. 6D show various conversion modes of TMCCT according to one embodiment of the application. In FIG. 6A to FIG. 6D, m>1.

FIG. 6A shows the boost mode. In FIG. 6A, the relationship between the input voltage V_{IN} and the output voltage Vox is as: Vox*(m-1)/m > V_{IN}; the inductor charging phase t₁ is expressed as t₁=I_{PK1Ox}*L/V_{IN}; the inductor discharging phase t₂ is expressed as: t₂= (I_{PK1Ox}*L)/(V_{OX} -V_{IN}); and the peak current control voltage V_{CX} is expressed as: V_{CX} =Q_{Ox0}*(V_{OX} -V_{IN})/(kC_{T}*V_{IN}).

FIG. 6B shows the buck-boost mode. In FIG. 6B, the relationship between the input voltage V_{IN} and the output voltage Vox is as: V_{OX}*(m-1)/m<V_{IN}< V_{OX}+V_{T}; the inductor charging phase t₁ is expressed as t₁=I_{PK1Ox}*L/V_{IN}; the inductor charging phase t₂ is expressed as: t₂= (I_{PK2Ox}-I_{PK1Ox})*L/(V_{IN}-V_{OX}); the inductor discharging phase t₃ is expressed as: t₃=I_{PK2Ox}*L/V_{OX}; and the peak current control voltage V_{CX} is expressed as: V_{CX} =Q_{Ox0}*(V_{OX})/(kC_{T}*V_{IN}).

FIG. 6C shows the buck mode. In FIG. 6C, the relationship between the input voltage V_{IN} and the output voltage Vox is as: V_{IN}>V_{OX}+V_{T}; the inductor charging phase t₂ is expressed as: t₂=I_{PK2Ox}*L/(V_{IN}-V_{OX}); the inductor discharging phase t₃ is expressed as: t₃=I_{PK2Ox}*L/V_{OX}; and the peak current control voltage V_{CX} is expressed as: V_{CX} =Q_{Ox0}*V_{OX}/(kC_{T}*V_{IN}).

FIG. 6D shows the inverting mode. In FIG. 6D, the inductor charging phase t₁ is expressed as: t₁=I_{PKN}*L/V_{IN}); the inductor discharging phase t₂ is expressed as: t₃=I_{PKN}*L/V_{OX}; and the peak current control voltage V_{CX} is expressed as: V_{CX} =Q_{Ox0}*V_{OX}/(kC_{T}*V_{IN}).

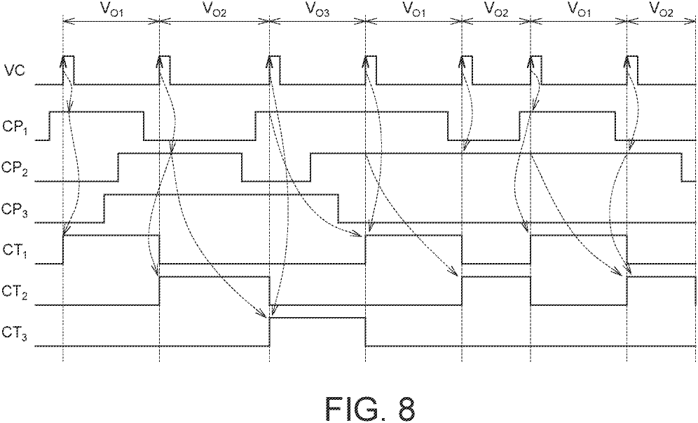

FIG. 7 shows operations of the mode decision circuit according to one embodiment of the application. The mode decision circuit 127 according to one embodiment of the application generates the mode signal MD based on the input voltage VIN, the channel select signal CHS and the output voltages V_{O1}, V_{O2}, ..., V_{Om}, V_{N}.

When the relationship between the input voltage V_{IN} and the output voltage Vox is as: Vox*(m-1)/m > V_{IN}, the mode decision circuit 127 generates the mode signal MD which indicates the boost mode (for example but not limited by, MD=10).

When the relationship between the input voltage V_{IN} and the output voltage Vox is as: V_{IN} >V_{OX}*(m-1)/m+V_{hys}, the mode decision circuit 127 generates the mode signal MD which indicates the buck-boost mode (for example but not limited by, MD=01).

When the relationship between the input voltage V_{IN} and the output voltage Vox is as: V_{IN} <V_{OX}+V_{T}, the mode decision circuit 127 generates the mode signal MD which indicates the buck-boost mode (for example but not limited by, MD=01).

When the relationship between the input voltage V_{IN} and the output voltage Vox is as: V_{IN}>V_{OX}+V_{T}+V_{hys}, the mode decision circuit 127 generates the mode signal MD which indicates the buck mode (for example but not limited by, MD=00).

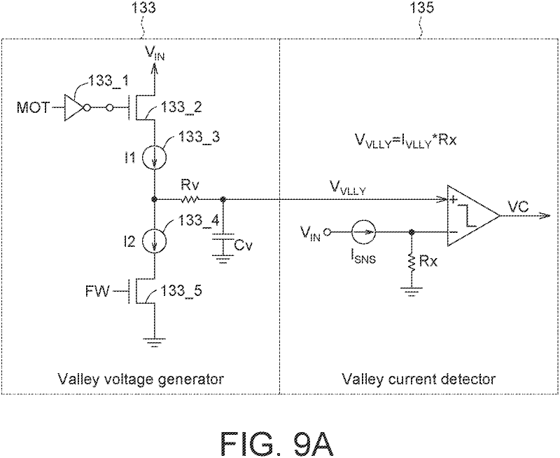

FIG. 8 shows the waveforms of the FIFO and priority logic 123 according to one embodiment of the application.

The FIFO and priority logic 123 loads the input signals (i.e. the voltage comparator output signals CP₁~CPₘ and/or CP_{N}) at the positive edge of the valley current VC with pre-set priority.

While more than one of the input signals concurrently go high at the positive edge of the valley current VC, all the high signals will be loaded into the FIFO and priority logic 123 with higher priority signals being placed first into the FIFO and priority logic 123.

The signal loaded first into the FIFO and priority logic 123 will be also first dumped out at the positive edge of the valley current VC signal. Only one output is selected in each time slot between two VC signals.

As shown in FIG. 8, at the first positive edge of the valley current VC, only the input signal CP₁ goes high. The high signal CP₁ is loaded into the FIFO and priority logic 123; and the signal CP₁ loaded first into the FIFO and priority logic 123 is also first dumped out as the signal CT₁ at the first positive edge of the valley current VC.

As shown in FIG. 8, at the second positive edge of the valley current VC, the input signals CP₂ and CP₃ go high at the same time. It is assumed that the priority is CP₁>CP₂>CP₃... > CP_{N}. The high signals CP₂ and CP₃ will be loaded into the FIFO and priority logic 123. In details, the high signal CP₂ having priority higher than the high signal CP₃ is first placed into the FIFO and priority logic 123, and the first-loaded high signal CP₂ is first dumped out as the signal CT₂ at the second positive edge of the valley current VC. Then, the high signal CP₃ having lower priority is placed into the FIFO and priority logic 123, and the second-loaded high signal CP₃ is second dumped out as the signal CT₃ at the third positive edge of the valley current VC.

By so, the FIFO and priority logic 123 loads the input signals (i.e. the voltage comparator output signals CP₁~CPₘ and/or CP_{N}) at the positive edges of the valley current VC with pre-set priority and dumped out at the positive edge of the valley current VC. The priority is assumed as CP₁>CP₂>CP₃... > CP_{N} in this example. However, the proposed method is not limited by this priority assumption and different priority assumption can be also achieved by modifying the priority logic apparently.

Operations of the TMCCT control logic 125 are described.

The mode signal MD means the power conversion mode for the selected channel, which can be buck, buck-boost, boost or inverting modes. The mode signal is generated from the mode decision circuit 127.

While a channel x is selected, the signal CTx will be high for the whole time slot between two valley current VC signals. The signal CTx is output from the FIFO and priority logic 123 as shown in FIG. 8.

For buck-boost conversion, the peak current signal PK13 terminates the 13 phase (i.e. the switches SW1 and SW3 are conducted) and the 1Oₓ phase (i.e. the switches SW1 and SWOₓ are conducted) is following. The peak current signal PK13 is generated from the peak current detector 131.

The Inductor current charging phases for all conversion modes are terminated by the peak current signal PKC which is generated from the peak current detector 131.

The peak current signals PKC and PK13 are response to the control voltage V_{CX} to transfer a constant charge Q_{Ox0} to the selected channel at the discontinuous conduction mode (DCM).

The inductor discharging phases for all conversion modes are terminated by the inductor current I_{L} discharged to the valley current level.

The valley current level is response to the valley current detector 135.

The channel selection signal CHS is used to inform the mode decision circuit 127 and the control voltage generator 129 to indicate the selected channel under processed.

The signal CG generated by the TMCCT control logic 125 is to reset and enable the peak current detector 131 that generates the peak current signals PKC and PK13.

The control voltage generator 129 generates the control voltage V_{CX} based on the channel select signal CHS, the mode signal MD, the input voltage VIN and the output voltages V_{O1}, V_{O2}, ..., V_{Om}, V_{N}. The channel select signal CHS indicates the selected channel to be processed of this time slot. The mode signal MD means power conversion mode for the selected channel, which can be buck, buck-boost, boost or inverting modes.

The control voltage VCX will be generated with response to the required conversion mode, the predetermined constant output charge Q_{Ox0}, the input voltage and the output voltage levels of the selected channel, as shown by equations above and in FIG. 6A to FIG. 6D.

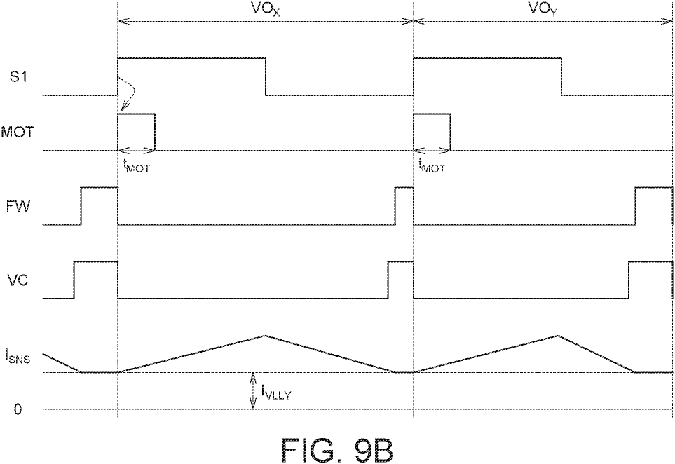

FIG. 9A shows a circuit diagram of the valley voltage generator 133 and the valley current detector 135 according to one embodiment of the application. FIG. 9B shows the waveforms of the valley voltage generator 133 and the valley current detector 135 according to one embodiment of the application.

The valley voltage generator 133 according to one embodiment of the application includes an inverter 133_1, a MOS transistor 133_2, a first current source 133_3, a second current source 133_4, a MOS transistor 133_5, a resistor Rv and a capacitor Cv.

The inverter 133_1 receives the minimum-on-time pulse signal MOT and outputs the inverted MOT to the gate of the MOS transistor 133_2. The minimum-on-time pulse signal MOT has a predetermined on-time and is triggered by the positive edge of the switch control signal S₁.

The MOS transistor 133_2 has a first terminal (for example but not limited by a source terminal) coupled to the input voltage V_{IN}, a second terminal (for example but not limited by a drain terminal) coupled to the first current source 133_3 and a control terminal (for example but not limited by a gate terminal) receiving the inverted MOT.

The first current source 133_3 is coupled to the MOS transistor 133_2 for generating a first constant current I1.

The second current source 133_4 is coupled to the MOS transistor 133_5 for generating a second constant current I2.

The MOS transistor 133_5 has a first terminal (for example but not limited by a source terminal) coupled to the second current source 133_4, a second terminal (for example but not limited by a drain terminal) coupled to ground and a control terminal (for example but not limited by a gate terminal) receiving the FW time period (the FW time period is generated by the AND logic 139 based on the switch control signals S₂ and S₃).

The resistor Rv is coupled to the first current source 133_3 and the second current source 133_4.

The capacitor Cv is coupled to the resistor Rv.

While the valley voltage V_{VLLY} is equal to zero, the valley current I_{VLLY} is also zero. While the valley voltage V_{VLLY} goes higher, the valley current I_{VLLY} also goes higher. Longer FW time period makes the valley voltage V_{VLLY} lower gradually even till zero. While FW time period is short enough, the valley voltage V_{VLLY} goes higher till FW time period becomes shorter than a predetermined value (t_{A}) and longer than another predetermined value (t_{B}).

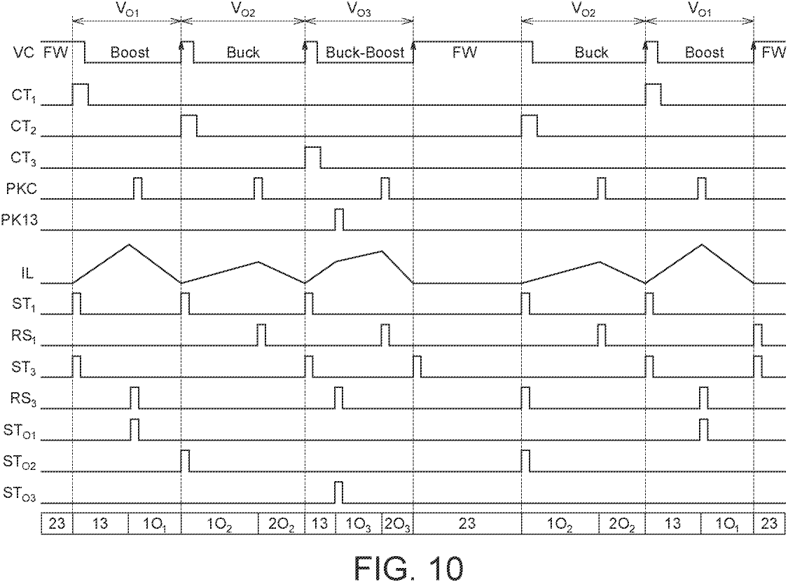

FIG. 10 shows an example of switch logic waveforms according to one embodiment of the application.

In the first positive edge of the valley current VC, the FIFO and priority logic 123 generates the high signal CT₁. Based on the high signal CT₁, the TMCCT control logic 125 generates the high signals ST₁ and ST₃. In response to the high signals ST₁ and ST₃, the logic control and gate driver 150 generates the high switch control signals S₁ and S₃ to conduct the switches SW1 and SW3. Because the switches SW1 and SW3 are turned on, energy is transferred from the input voltage V_{IN} to the inductor L₁. Thus, the inductor current I_{L} is increased. During the inductor charging phase, when the inductor current I_{L} is increased from the DC current I_{DC} (equal to the valley current I_{VLLY}) to “I_{DC}+I_{PK1Ox}”, the peak current signal PKC is triggered by the peak current detector 131. In response to the peak current signal PKC, the TMCCT control logic 125 generates the signal ST_{O1} and RS₃; and in response the signal RS₃, the logic control and gate driver 150 generates a low signal S₃ to turn-off the SW3 and the high signal S₁ and S_{O1} to turn-on the switches SW1 and SWO₁ for discharging the inductor current I_{L} to the output node, till the inductor current I_{L} to zero.

Other switching cycles are similar and thus the details are omitted.

As described above, one embodiment of the application provides a single inductor multiple-output (or SIMBO) DC-DC converter comprising: a time multiplexing constant charge transferred (TMCCT) control logic having valley current control by transferring electrical energy to output sequentially (1-by-1), a control voltage generator generating a control voltage V_{CX} to the peak current detector to control the respective output charges of the output channels as respective constant predetermined values. Also, the valley current is response to the load current (i.e. the current sense I_{SNS}) to a value that can make input and output power be balance so that the SIMO or SIMBO DC-DC converter can operate at both DCM and CCM.

Still further, in one embodiment of the application, each conversion for each positive output V_{O1}~V_{Om} can be operated at the buck, the boost or the buck-boost mode in response to the input voltage V_{IN} and the output voltage conditions.

Still further, in one embodiment of the application, one of the outputs can be operated at inverting mode (i.e. one of the outputs can have negative output voltage).

Still further, in one embodiment of the application, the conversion mode of the selected channel is decided by the mode decision circuit.

Still further, in one embodiment of the application, the valley current level is in response to freewheel (FW) duty cycles. If the freewheel (FW) duty cycle is larger than a first time interval t_{A}, the valley current level is decreased; and if the freewheel (FW) duty cycle is smaller a second time interval t_{B} the valley current level is increased. The first time interval is equal to or larger than the second time interval. The valley current level is equal to or larger than zero value.

Still further, in one embodiment of the application, the control circuit 120 is in response to each output and the FIFO and Priority circuit decides the selected output channel for the time instance.

Still further, in one embodiment of the application, the TMCCT control logic decides the switching sequence for the selected channel in response to outputs from the valley current detector, the peak current detector, and the mode decision circuit.

Still further, in one embodiment of the application, for loading that DCM cannot support, the valley voltage generator and the valley current detector will raise the valley current to increase the output current capability as a CCM.

Still further, in one embodiment of the application, the power stage (110) can be multiple positive output rails and multiple negative output rails.

The application gains some of the limited space in the space-constrained electronic products back by using the single-inductor multiple-output (SIMO) or SIMBO DC-DC converter architecture. The SIMO or SIMBO architecture enables to extend battery life for space-constrained electronic products.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A DC-DC converter including:
a power stage having an inductor and a plurality of switches coupled to the inductor, the power stage generating a plurality of output voltages from an input voltage;
a control circuit coupled to the power stage, the control circuit performing time multiplexing constant charge transfer control having valley current control by transferring electrical energy from the input voltage to the plurality of output voltages sequentially one-by-one, the control circuit further generating a control voltage to control respective output charges of the plurality of output voltages as respective constant predetermined values, and the control circuit response to all load currents for making input power and output power balance by automatically generating a valley current so that the DC-DC converter switches between a discontinuous conduction mode (DCM) and a continuous conduction mode (CCM) depending on different valley current levels; and
a logic control and gate driver, coupled to the control circuit and the power stage, the logic control and gate driver generating a plurality of switch control signals based on a plurality of control signals from the control circuit, the plurality of switch control signals for controlling the plurality of switches of the power stage.

2. The DC-DC converter according to claim 1, wherein the DC-DC converter is either a single-inductor multiple-output (SIMO) or a single inductor multiple bipolar output (SIMBO) DC-DC converter.

3. The DC-DC converter according to claim 1, wherein
each conversion for each positive output voltage among the plurality of output voltages is operated at a buck mode, a boost mode or a buck-boost mode in response to conditions of the input voltage and the output voltage.

4. The DC-DC converter according to claim 1, wherein one of the output voltages is operated at an inverting mode.

5. The DC-DC converter according to claim 1, wherein a conversion mode of a selected channel is decided by a mode decision circuit of the control circuit.

6. The DC-DC converter according to claim 1, wherein the control circuit includes a first-in-first-out (FIFO) and priority logic for performing FIFO and priority determination on a plurality of voltage comparator outputs from a voltage comparator circuit of the control circuit when triggered by a valley current detection result;
the FIFO and priority logic loads the voltage comparator outputs at positive edges of a valley current signal according to a pre-set priority;
while more than one of the voltage comparator outputs concurrently go high at the positive edge of the valley current signal, the high voltage comparator outputs are sequentially loaded into the FIFO and priority logic according to the pre-set priority;
the voltage comparator output loaded first into the FIFO and priority logic is first dumped out at the positive edge of the valley current signal;
only one output is selected in each time slot between two of the valley current signals; and
the control circuit is in response to each output, and the FIFO and Priority circuit decides the selected output channel for a time instance.

7. The DC-DC converter according to claim 6, wherein the control circuit includes a time multiplexing constant charge transferred (TMCCT) control logic coupled to the FIFO and priority logic,
while a channel is selected, a corresponding output signal from the FIFO and priority logic is high for a whole time slot between two of the valley current signals;
for a DC-DC conversion, a first peak current signal generated from a peak current detector terminates an inductor current charging phase and an inductor current discharging phase is following;
the Inductor current charging phases for all conversion modes are terminated by the first peak current signal;
the first peak current signal and a second peak current signal are response to the control voltage to transfer a constant charge to the selected channel at the discontinuous conduction mode;
the inductor discharging phases for all conversion modes are terminated by the inductor current discharged to a valley current level among the different valley current levels;
the valley current level is response to a valley current detection result of the control circuit;
a channel selection signal is used to indicate the selected channel under processed; and
an enable signal generated by the TMCCT control logic is to reset and enable the peak current detector.

8. The DC-DC converter according to claim 7, wherein the control circuit further includes a control voltage generator generating the control voltage based on the channel select signal, a mode signal, the input voltage and the output voltages;
the control voltage is generated with response to the required conversion mode, the predetermined constant output charge, the input voltage and the output voltage of the selected channel.

9. The DC-DC converter according to claim 8, wherein
the valley current level is in response to the freewheel duty cycles;
if the freewheel duty cycle is larger than a first time interval, the valley current level is decreased;
if the freewheel duty cycle is smaller a second time interval, the valley current level is increased, wherein the first time interval is equal to or larger than the second time interval;
if the freewheel duty cycle is equal to the first and second time intervals, the valley current level is not changed;
if the freewheel duty cycle is smaller than the first time interval and larger than the second time interval, the valley current level is not changed; and
the valley current level is equal to or larger than zero value.

10. The DC-DC converter according to claim 9, wherein the TMCCT control logic decides a switching sequence for the selected channel in response to the valley current detection result, a peak current detection result and a mode decision result.

11. A control method for a DC-DC converter, the control method including:
generating a plurality of output voltages from an input voltage by a power stage having an inductor and a plurality of switches coupled to the inductor;
performing time multiplexing constant charge transfer control having valley current control by transferring electrical energy from the input voltage to the plurality of output voltages sequentially one-by-one;
generating a control voltage to control respective output charges of the plurality of output voltages as respective constant predetermined values;
response to all load currents, making input power and output power balance by automatically generating a valley current so that the DC-DC converter switches between a discontinuous conduction mode (DCM) and a continuous conduction mode (CCM) depending on different valley current levels; and
generating a plurality of switch control signals based on a plurality of control signals, the plurality of switch control signals for controlling the plurality of switches of the power stage.

12. The control method for the DC-DC converter according to claim 11, wherein the DC-DC converter is either a single-inductor multiple-output (SIMO) or a single inductor multiple bipolar output (SIMBO) DC-DC converter.

13. The control method for the DC-DC converter according to claim 11, wherein
each conversion for each positive output voltage among the plurality of output voltages is operated at a buck mode, a boost mode or a buck-boost mode in response to conditions of the input voltage and the output voltage.

14. The control method for the DC-DC converter according to claim 11, wherein one of the output voltages is operated at an inverting mode.

15. The control method for the DC-DC converter according to claim 11, wherein a conversion mode of a selected channel is decided by a mode decision result.

16. The control method for the DC-DC converter according to claim 11, further including:
performing FIFO and priority determination on a plurality of voltage comparator outputs when triggered by a valley current detection result;
loading the voltage comparator outputs at positive edges of a valley current signal according to a pre-set priority;
while more than one of the voltage comparator outputs concurrently go high at the positive edge of the valley current signal, the high voltage comparator outputs are sequentially loaded according to the pre-set priority;
the voltage comparator output loaded first is first dumped out at the positive edge of the valley current signal;
only one output is selected in each time slot between two of the valley current signals; and
deciding the selected output channel for a time instance.

17. The control method for the DC-DC converter according to claim 16, further including:
performing time multiplexing constant charge transferred (TMCCT) control,
while a channel is selected, a corresponding output signal from the FIFO and priority determination is high for a whole time slot between two of the valley current signals;
for a conversion, a first peak current signal terminates an inductor current charging phase and an inductor current discharging phase is following;
the Inductor current charging phases for all conversion modes are terminated by the first peak current signal;
the first peak current signal and a second peak current signal are response to the control voltage to transfer a constant charge to the selected channel at the discontinuous conduction mode;
the inductor discharging phases for all conversion modes are terminated by the inductor current discharged to a valley current level among the different valley current levels;
the valley current level is response to a valley current detection result;
a channel selection signal is used to indicate the selected channel under processed; and
an enable signal generated by the TMCCT control is to reset and enable the peak current detection.

18. The control method for the DC-DC converter according to claim 17, wherein the control voltage is generated based on the channel select signal, a mode signal, the input voltage and the output voltages;
the control voltage is generated with response to the required conversion mode, the predetermined constant output charge, the input voltage and the output voltage of the selected channel.

19. The control method for the DC-DC converter according to claim 18, wherein
the valley current level is in response to the freewheel duty cycles;
if the freewheel duty cycle is larger than a first time interval, the valley current level is decreased;
if the freewheel duty cycle is smaller a second time interval, the valley current level is increased;
the first time interval is equal to or larger than the second time interval;
if the freewheel duty cycle is equal to the first and second time intervals, the valley current level is not changed;
if the freewheel duty cycle is smaller than the first time interval and larger than the second time interval, the valley current level is not changed; and
the valley current level is equal to or larger than zero value.

20. The control method for the DC-DC converter according to claim 19, wherein the TMCCT control decides a switching sequence for the selected channel in response to the valley current detection result, a peak current detection result and a mode decision result.
